(19) United States
(12) Patent Application Publication
(10) Pub. No.: US 2010/0285168 A1
(43) Pub. Date: Nov. 11, 2010

(54) ANTISTATIC SILICONE RUBBER MOLD-MAKING MATERIAL

(76) Inventors: Hiroshi MOGI, Annaka-shi (JP); Michihisa Hara, Annaka-shi (JP)

Correspondence Address: BIRCH STEWART KOLASCH & BIRCH, PO BOX 747, FALLS CHURCH, VA, 22040-0747, US

(21) Appl. No.: 12/839,871

(22) Filed: Jul. 20, 2010

Related U.S. Application Data
(63) Continuation of application No. 12/104,964, filed on Apr. 17, 2008.

(30) Foreign Application Priority Data
Apr. 18, 2007 (JP) 2007-109305

(51) Int. Cl. B28B 7/06; B29C 33/40

(52) U.S. Cl. 425/440; 264/225

(57) ABSTRACT

An antistatic silicone rubber mold-making material is provided. This mold-making material comprises a silicone rubber composition which is curable by an addition reaction, and which contains an ionically conductive antistatic agent. The article produced by curing this antistatic silicone rubber mold-making material retains the insulator performance and the article exhibits excellent antistatic properties. Also, the article can be colored as desired.

### CROSS-REFERENCE TO RELATED APPLICATION

This is a Continuation Application of U.S. application Ser. No. 12/104,964 filed Apr. 17, 2008, which is a non-provisional application which claims priority under 35 U.S.C. §119(a) on Patent Application No. 2007-109305 filed in Japan on Apr. 18, 2007, the entire contents of which are hereby incorporated by reference.

### TECHNICAL FIELD

This invention relates to a silicone rubber mold-making material, and more specifically, to an antistatic silicone rubber mold-making material which exhibits rubber-like texture after curing, which can be used in the mold-making requiring high releasability of the molded article from the mold as in the case of molding a test model, namely, in the molding of a prototype, and which also exhibits excellent electric insulation with sufficient antistatic performance.

In the present invention, a “mold-making material” is a material which is not yet cured and which is fluid before the curing. This material is brought in contact with the entire surface or a part thereof of a master by injection or coating so that it cures into a mold that can be used in the molding of copy articles by using a resin or the like. In addition, the term “releasability” used in the present invention includes not only the releasability of the cured mold from the master, but also, the releasability of the copy articles from the thus produced mold.

### BACKGROUND ART

Silicone rubber has been used in a wide variety of applications by making full use of its excellent heat resistance, low temperature resistance, and electric properties. One such application has been mold-making material where a high releasability is critical. In the field of electronic appliance, office machines, home appliance, automobile parts, and the like, importance of prototype molding in the stage of product development and sample manufacture is highly recognized since such prototype molding is highly effective in reducing the overall cost and time. In view of the workability, a liquid silicone rubber composition which cures by an addition reaction is finding a greater use.

Such silicone rubber composition is generally provided in the form of a composition comprising an organopolysiloxane having a high degree of polymerization and a reinforcement filler. This composition has been produced by blending the base polymer with a reinforcement filler and various dispersants in a blender such as universal kneader or a kneader. Organopolysiloxane and reinforcement fillers such as silica are insulators, and the silicone rubber composition prepared by incorporating such reinforcement filler and the product obtained by curing such composition will be electrostatically charged when they are brought in contact with various substances. Because of such electrostatic charge, the dust floating in the air as well as burrs and fragments of the resin such as polyurethane resin or epoxy resin will be adsorbed on the product, and this resulted in the extremely poor workability and generation of unacceptable articles in the subsequent shot.

Antistatic rubbers have been produced by using a polyether antistatic agent (Patent Document 1: JP-A 2002-500237) or a carbon black antistatic agent (Patent Documents 2 and 3: JP-A 2002-507240 and JP-A 2002-327122). Use of the polyether antistatic agent has been associated with the problem of decomposition of the polyether at a high temperature which resulted in the failure of realizing sufficient antistatic effects. Addition of the polyether also resulted in the change of the state of the composition, and the rubber which became non-sagging could no longer be used as a silicone mold-making material.

### DISCLOSURE OF THE INVENTION

An object of the present invention is to provide an antistatic silicone rubber mold-making material which cures into a highly antistatic silicone rubber without loosing its insulator performance.

In order to realize the object as described above, the inventors of the present invention made an intensive study and found that such problem can be solved by adding a small amount of ionically conductive antistatic agent in the silicone rubber composition which cures by an addition reaction. The present invention has been completed on the basis of such finding.

Accordingly, the present invention provides an antistatic silicone rubber mold-making material comprising an addition reaction curable silicone rubber composition containing an ionically conductive antistatic agent.

### EFFECTS OF THE INVENTION

The article produced by curing the antistatic silicone rubber mold-making material of the present invention retains the insulator performance and the article exhibits excellent antistatic properties. Also, the article can be colored as desired.

### DESCRIPTION OF THE PREFERRED EMBODIMENTS

The antistatic silicone rubber mold-making material of the present invention comprises a silicone rubber composition which is curable by an addition reaction, and this material has an ionically conductive antistatic agent added thereto. The silicone rubber composition which is curable by addition preferably comprises:

(A) a polyorganosiloxane containing at least two aliphatic unsaturated monovalent hydrocarbon groups, and in particular, at least two alkenyl groups per molecule,

(B) a polyorganohydrogensiloxane containing at least two hydrogen atoms bonded to silicon atoms (SiH groups) per molecule,

(C) a catalyst for the addition reaction,

(D) an inorganic filler, and

(E) an ionically conductive antistatic agent.

The polyorganosiloxane (A) used in the present invention is the base polymer in the mold-making material of the present invention. This component (A) may be any polyorganosiloxane as long as it has at least two monovalent aliphatic unsaturated hydrocarbon groups bonded to the silicon atoms per molecule, and it is capable of forming a network structure by an addition reaction.

Exemplary monovalent aliphatic unsaturated hydrocarbon groups include alkenyl groups containing 2 to 6 carbon atoms such as vinyl, allyl, 1-butenyl, and 1-hexenyl, and the most advantageous is vinyl group in view of the ease of the synthesis, fluidity of the composition before the curing, and retention of the heat resistance of the composition after curing.

Other organic groups which may be bonded to the silicon atom in the component (A) include a substituted or unsubstituted monovalent hydrocarbon group containing 1 to 10 carbon atoms excluding the monovalent aliphatic unsaturated hydrocarbon group, and examples include alkyl groups such as methyl, ethyl, propyl, butyl, pentyl, hexyl, octyl, decyl, and dodecyl; aryl groups such as phenyl; aralkyl groups such as benzyl, 2-phenylethyl, and 2-phenylpropyl; a substituted hydrocarbon groups such as chloromethyl, chlorophenyl, 2-cyanoethyl, and 3,3,3-trifluoropropyl. Among these, the most preferred is methyl group in view of ease of synthesis, favorable mechanical strength, and good balance between various properties including the fluidity before the curing.

The monovalent aliphatic unsaturated hydrocarbon group may be included at the end and/or at the side of the molecular chain of the polyorganosiloxane (A). However, when the molecular chain is a straight chain, the monovalent aliphatic unsaturated hydrocarbon group is preferably included at least at opposite ends of the molecular chain in view of realizing excellent mechanical properties after the curing of the composition.

The siloxane skeleton may be either a straight chain or a branched skeleton. However, in order to improve the mechanical properties of the composition after its curing, and in the case of making a mold of a master having a complicated shape as in the case of prototype molding, use of a mixture of a straight chain polydiorganosiloxane and a branched polyorganosiloxane is preferable. However, when the mold is used with an epoxy resin, and in particular, with a transparent epoxy resin which requires an extremely high surface smoothness, presence of a branched polyorganosiloxane may result in the increase of the hardness of the silicone rubber mold or loss of the smoothness of the mold surface due to the resin formation of such branched polyorganosiloxane. It should also be noted, when such mixture is used, the polyorganosiloxane of the component (A) may comprise a mixture containing 2 to 40% by weight of a branched polyorganosiloxane having an R₃SiO_{1/2} unit, SiO₂ unit, and optionally, an R₂SiO unit (wherein R is the organic group or the monovalent aliphatic unsaturated hydrocarbon group as defined above, wherein at least two, and preferably at least three units per molecule is a monovalent aliphatic unsaturated hydrocarbon group) and the remainder of a straight chain polydiorganosiloxane terminated at both ends with a monovalent aliphatic unsaturated hydrocarbon group having a backbone comprising an R₂SiO unit and the ends comprising an R₃SiO_{1/2} unit in order to improve mechanical strength and modulus of the cured product.

The component (A) may have a degree of polymerization such that the viscosity at 25° C. as measured by an Ostwald viscosimeter is 500 to 500,000 mm²/s, and preferably 1,000 to 100,000 mm²/s so that the composition before the curing has good fluidity and workability and the composition, once cured, exhibits an appropriate elasticity.

The polyorganohydrogensiloxane (B) used in the present invention functions as a crosslinking agent for the component (A) by the addition reaction of the hydrosilyl group (SiH group) in the molecule with the monovalent aliphatic unsaturated hydrocarbon group in the component (A), and it should have at least two, and more preferably, at least three hydrogen atoms bonded to the silicon atoms which will be involved in the addition reaction so that the cured product has a net work structure.

Examples of the organic group which is bonded to the silicon atom of the siloxane unit include those mentioned for the component (A) as the organic group other than the monovalent aliphatic unsaturated hydrocarbon group. Among these, the most preferred is methyl group in view of the ease of synthesis.

The siloxane skeleton of the component (B) may be either straight chain, branched, cyclic, or a mixture thereof. The preferred, however, is a straight chain skeleton.

The component (B) is not particularly limited for the degree of polymerization. However, since synthesis of a polyorganohydrogensiloxane having two or more hydrogen atoms bonded to the same single silicon atom is difficult, the component (B) preferably comprises at least 3 siloxane units, and in view of the handling convenience and unlikeliness of volatilization during storage and in the course of heating for the curing, the viscosity at 25° C. as measured by Ostwald viscosimeter is preferably 15 to 200 mm²/s.

The component (B) may be incorporated at an amount such that 0.5 to 5, and preferably 1 to 3 hydrogen atoms bonded to the silicon atom in the component (B) are present in relation to one monovalent aliphatic unsaturated hydrocarbon group in the component (A). When the component (B) is incorporated at an amount such that hydrogen atom ratio is less than 0.5, the curing will not be completed, and the mold produced by curing the composition will by tacky, and releasability of the silicone rubber mold from the master as well as releasability of the copy articles from the silicone rubber mold will be sacrificed. In contrast, incorporation at the hydrogen atom ratio in excess of 5 will invite foaming in the course of curing, and the bubbles will be accumulated at the interface between the master and the silicone rubber mold or at the interface between the silicone rubber mold and the copy articles. As a consequence, the resulting silicone rubber mold or the copy articles will present an irregular surface, and the resulting silicone rubber mold will also be brittle. This may result in the reduced number of resin molding cycles, and shorter life and reduced mechanical strength of the silicone rubber mold.

The catalyst for the addition reaction (C) used in the present invention is preferably a platinum compound. The platinum compound is a catalyst for promoting the addition reaction between the monovalent aliphatic unsaturated hydrocarbon group in the component (A) and the hydrosilyl group in the component (B). The platinum compound has the merit that it exhibits high catalytic performance for the curing at a temperature near the room temperature.

Exemplary platinum compounds include chloroplatinic acid, a complex obtained by reacting chloroplatinic acid with an alcohol, a platinum-olefin complex, a platinum-vinyl siloxane complex, a platinum-ketone complex, and a platinum-aldehyde complex.

Among these, the preferred are the reaction products of chloroplatinic acid and an alcohol, a platinum-vinyl siloxane complex, and the like in view of the favorable solubility in the components (A) and (B) and high catalytic activity.

The component (C) may be incorporated at an amount in terms of the weight of the platinum atom of 1 to 100 ppm, and preferably 2 to 50 ppm in relation to the component (A). When incorporated at a content of less than 1 ppm, the curing speed will be unduly low, and due to the incomplete curing, the silicone rubber mold will be tacky, and releasability of the silicone rubber mold from the master as well as releasability of the copy articles from the silicone rubber mold will be sacrificed. Incorporation in excess of 100 ppm results in an unduly high curing speed, and hence, loss of the workability after the blending of the components. Such excessive incorporation is also uneconomical.

The inorganic filler component (D) in the present invention imparts mechanical properties with the cured composition. Exemplary inorganic fillers include silica powders such as fumed silica, precipitated silica, molten silica, pulverized quartz, and diatomaceous earth; and such silica powder hydrophobicized by the means of refluxing, suspending, normal pressure fluidized bed, pressurized fluidized bed using a surface treating agent such as hexamethyldisilazane, organoalkoxysilane, organohalogenosilane, or a straight chain or cyclic organopolysiloxane having a low degree of polymerization. Exemplary inorganic fillers also include powders such as calcium carbonate, aluminum silicate, titanium oxide, zinc oxide, iron oxide, and carbon black. In view of realizing favorable mechanical properties, the preferred is fumed silica, and the more preferred is fumed silica surface treated with a silazane such as hexamethyldisilazane.

The component (D) may be incorporated at a content of 5 to 100 parts by weight, and preferably, 10 to 50 parts by weight in relation to 100 parts by weight of the component (A) in view of the favorable mechanical properties of the silicone rubber mold produced by the curing.

In the present invention, an ionically conductive antistatic agent is incorporated as component (E) in the silicone rubber composition curable by an addition reaction comprising the components (A) to (D).

The ionically conductive antistatic agent incorporated in the silicone rubber composition (antistatic silicone rubber mold-making material) of the present invention is not particularly limited as long it is an ionically conductive substance and not an electroconductive substance like carbon black. The preferred are lithium salts.

Exemplary lithium salts include LiBF₄, LiClO₄, LiPF₆, LiAsF₄, LiSbF₆, LiSO₃CF₃, LiN(SO₂CF₂)₂, LiCSO₃C₄F₉, LiC(SO₂CF₃)₃, and LiB(C₆H₅)₄, which may be used alone or in combination of two or more.

The ionically conductive antistatic agent is preferably added in the form of a paste in a polyorganosiloxane to improve dispersion in the silicone rubber composition and enable stable functioning. In this case, the polyorganosiloxane used may be either a raw rubber-like or an oily polyorganosiloxane, and the preferred are dimethylpolysiloxane and methylvinylpolysiloxane. In this case, the polyorganosiloxane may be a part of the polyorganosiloxane component (A), and a part of the inorganic filler component (D) may be incorporated as the filler component in the paste. This paste may also contain an inorganic filler such as a reinforcement silica or diatomaceous earth for improving the workability. Concentration of the ionically conductive antistatic agent in the paste is preferably 2 to 90% by weight, more preferably 5 to 80% by weight, and most preferably 10 to 50% by weight.

The ionically conductive antistatic agent may be incorporated at a content of 0.0001 to 5 parts by weight, preferably 0.0005 to 3 parts by weight, more preferably 0.001 to 1 parts by weight, and most preferably 0.001 to 0.5 parts by weight in relation to 100 parts by weight of the component (A). When incorporated at less than 0.0001 parts by weight, the antistatic effect may be insufficient, while incorporation at a content higher than 5 parts by weight may result in the loss of insulation, or adverse effects on the physical properties or heat resistance of the silicone rubber.

The silicone rubber composition which is curable by an addition reaction (the silicone rubber mold-making material) of the present invention can also contain various other optional components as long as the characteristic feature of the present invention is not adversely affected. For example, it may contain a cure retarder such as an acetylene compound, diallyl maleate, triallyl isocyanurate, a nitryl compound, or an organic peroxide in order to improve workability of the mold-making material by extending the time required for the curing of the silicone rubber mold-making material of the present invention at room temperature. The silicone rubber mold-making material may also contain, for example, a mold release agent, pigment, plasticizer, flame retardant agent, thixotropic agent, antibacterial, or fungicide.

The antistatic silicone rubber mold-making material of the present invention may be produced by homogeneously kneading the components (A) to (E) and other optional components by a blending means such as planetary mixer, Shinagawa mixer, universal kneader, or a kneader. In a typical embodiment, the components including the component (B) and the components including the component (C) may be separately prepared and stored, and these components may be homogeneously mixed immediately before the use. However, all components may be stored in the same container in the presence of a cure retarder.

When the mold-making material of the present invention is stored in two or more containers, the components should be homogeneously blended followed by degassing, while the material stored in one container can be used as it is for the mold preparation. The mold-making material is then injected or coated on the surface of the master to entirely or partly cover the surface, and the material is then cured to produce a silicone rubber mold. The mold-making material is typically cured by heating the material to a temperature of about 35 to 60° C., and if desired, the curing may be promoted by heating to a higher temperature of up to 150° C. After the curing, the rubber mold is released from the master for use in the production of copy articles by introducing a molding resin in the thus prepared mold and curing the resin at an appropriate curing temperature.

The cured product may preferably have a volume resistivity of at least 1 GΩ·m, and in particular, at least 2 GΩ·m, and the product will have the volume resistivity level sufficient for the use.

The antistatic performance is preferably such that, when the surface of the silicone rubber is electrostatically charged by corona discharge using Static Honestmeter (manufactured by Shishido Electrostatic, LTD.) to 6 kV, and the time required for the charge voltage to become half its original value (half life) is measured, the time is up to 2 minutes, and in particular, up to 1 minute.

### EXAMPLES

Next, the present invention is described in further detail by referring to the Examples and the Comparative Examples which by no means limit the scope of the present invention. In the following Examples and the Comparative Examples, “parts” means “parts by weight” and the viscosity is the one measured with an Ostwald viscosimeter at 25° C.

The electric charge and the volume specific resistance were measured by the procedures as described below.

### [Measurement of Electric Charge]

The surface of the molded article was electrostatically charged by corona discharge using Static Honestmeter (manufactured by Shishido Electrostatic, LTD.). Next, the time required for the charge voltage to become half the original value was measured.

### [Measurement of Volume Specific Resistance]

Volume specific resistance was measured by JIS-K6249.

An antistatic paste was prepared as described below.

### Preparation of Antistatic Paste (1)

42 parts of dimethylpolysiloxane terminated with trimethylsilyl group; 8 parts of hydrophobicized fumed silica (R-972 manufactured by Nippon Aerosil) having a specific surface area of 110 m²/g, and 50 parts of adipate ester containing 20% by weight of LiN(SO₂CF₃)₂ were kneaded to prepare an antistatic paste (1).

### Preparation of Antistatic Paste (2)

As an antistatic agent, 42 parts of dimethylpolysiloxane terminated with trimethylsilyl group, 8 parts of hydrophobicized fumed silica (R-972 manufactured by Nippon Aerosil) having a specific surface area of 110 m²/g, 50 parts of polyether modified silicone oil (KF351F, manufactured by Shin-Etsu Chemical Co., Ltd.) having a viscosity at 25° C. of 75 mm²/s were kneaded to prepare an antistatic paste (2).

### Example 1

100 parts of a straight chain polymethylvinylsiloxane having both ends terminated with dimethylvinylsilyl group and containing dimethylsiloxy unit as the intermediate units having a viscosity of 10,000 mm²/s, 40 parts of fumed silica (having a specific surface area determined by BET method of 200 m²/g), 5 parts of hexamethyldisilazane, and 2.5 parts of water were kneaded in a kneader at room temperature for 1 hour. Next, the interior temperature of the kneader was gradually elevated to 160° C. in 60 minutes, and kneading was continued at this temperature for another 4 hours. After cooling to room temperature, the antistatic paste (1) was added to this composition at an amount of 0.05 parts of the antistatic paste (1) in relation to 100 parts of the composition. Silicone compound (1) was thereby produced.

### Preparation of Curing Agent

100 parts of dimethylpolysiloxane terminated at both ends with dimethylvinylsiloxy group having a viscosity of 1,000 mm²/s (content of the vinyl group, 0.2% by weight); (B) 3 parts of methylhydrogenpolysiloxane terminated at both ends with trimethylsiloxy group having a viscosity of 30 mm²/s (content of the hydrogen atom forming the SiH bond, 1.5% by weight); and (C) 0.3 parts of the catalyst fine particles prepared by dispersing a complex of chloroplatinic acid and vinyl siloxane in a thermoplastic silicone resin having a softening point of 80 to 90° C. (an amount corresponding to the amount of the metal platinum in the catalyst of 5 ppm in the present composition) were homogeneously mixed to prepare a curing agent (1).

The silicone compound (1) was mixed with the curing agent (1), and a sheet having a thickness of 2 mm was produced by using this silicone rubber composition. The sheet was cured at 60° C. for 4 hours.

The thus prepared silicone rubber was evaluated for its electric charge (half life) and volume specific resistance. The results are shown in Table 1.

### Example 2

The procedure of Example 1 was repeated except that the amount of the antistatic paste (1) added was reduced to 0.01 parts to measure the electric charge (the half life) and the volume specific resistance. The results are shown in Table 1.

### Comparative Example 1

The procedure of Example 1 was repeated without adding any antistatic agent to measure the electric charge (the half life) and the volume specific resistance. The results are shown in Table 1.

### Comparative Example 2

The procedure of Example 1 was repeated except for the use of the antistatic paste (2) instead of the antistatic paste (1) to measure the electric charge (the half life) and the volume specific resistance. The results are shown in Table 1.

Adsorption of dust and burr (broken projections) of the introduced resin on the silicone mold-making material was confirmed by visual inspection.

The number of urethane resin molding cycles that could be conducted was measured by the following procedure.

### <Procedure>

Durability of the silicone mold-making material was measured by the number of urethane resin molding cycles.
1. The urethane resin was introduced in the silicone rubber mold (master for the mold-making).
2. The introduced urethane resin is cured at 70° for 30 minutes.
3. The cured urethane resin was removed from the silicone rubber mold.

The steps 1 to 3 were repeated, and the number of cycles was counted until the silicone rubber mold could no longer be used due to the peeling caused by the adhesion of the cured urethane resin to the silicone rubber mold.

TABLE 1

| | Example | | Comparative Example | |
|---|---|---|---|---|
| | 1 | 2 | 1 | 2 |
| State of the material | Sagging | Sagging | Sagging | Non-sagging |
| Half life (6 kV) | 1 sec | 1 sec | 120 sec | 80 sec |
| Volume specific | 1.20 × 10¹⁵ | 1.50 × 10¹⁵ | 1.10 × 10¹⁵ | 1.30 × 10¹⁵ |
| resistance (Ω · m) | | | | |
| Adsorption of dust and burrs | No | No | Yes | Yes |
| of the introduced resin | | | | |
| Number of urethane resin | 65 | 63 | 60 | 45 |
| molding cycles | | | | |

Japanese Patent Application No. 2007-109305 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of preparing a rubber mold for use in the production of copy articles by introducing a molding resin in said rubber mold and curing the resin comprising the step of injecting or coating an antistatic silicone rubber mold-making material on the surface of a master to entirely or partly cover the surface, curing the mold-making material to produce the silicone rubber mold, and releasing the silicone rubber mold from the master,
said antistatic silicone rubber mold-making material comprising an addition reaction curable silicone rubber composition containing an ionically conductive antistatic agent.

2. The method of claim 1 wherein in the antistatic silicone rubber mold-making material, the ionically conductive antistatic agent is a lithium salt.

3. The method of claim 2 wherein in the antistatic silicone rubber mold-making material, the ionically conductive antistatic agent is at least one member selected from the group consisting of LiBF₄, LiClO₄, LiPF₆, LiAsF₆, LiSbF₆, LiSO₃CF₃, LiN(SO₂CF₃) ₂, LiSO₃C₄F₉, LiC(SO₂CF₃)₃, and LiB(C₆H₅)₄.

4. The method of claim 1 wherein in the antistatic silicone rubber mold-making material, the ionically conductive antistatic agent is in the form of a paste in an organopolysiloxane.

5. The method of claim 1 wherein in the antistatic silicone rubber mold-making material, the addition reaction curable silicone rubber composition comprising
(A) a polyorganosiloxane containing at least two aliphatic unsaturated monovalent hydrocarbon groups,
(B) a polyorganohydrogensiloxane containing at least two hydrogen atoms bonded to silicon atoms (SiH groups) per molecule,
(C) a catalyst for the addition reaction,
(D) an inorganic filler, and
(E) an ionically conductive antistatic agent.

6. The method of claim 1 wherein in the antistatic silicone rubber mold-making material, the cured product has a volume resistivity of at least 1 GΩ·m.

7. A rubber mold obtained by the method of claim 1.
